(19) United States
(12) Patent Application Publication
(10) Pub. No.: US 2003/0132909 A1
(43) Pub. Date: Jul. 17, 2003

(54) Pointing device attribute variance based on distance/time ratio

(75) Inventor: Thomas R. Haynes, Apex, NC (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY

(21) Appl. No.: 10/044,728

(22) Filed: Jan. 11, 2002

(51) Int. Cl. G09G 5/00

(52) U.S. Cl. 345/156

(57) ABSTRACT

The present invention provides a method, apparatus, and computer instructions for changing a pointer based on rate of movement of a pointing device. The present invention automatically changes a pointer based on user defined thresholds and the rate of movement of the pointing device. The user defines the changes for the pointer with respect to given thresholds.

### FIELD OF THE INVENTION

The present invention relates to an improved pointing device driver in a data processing system. In particular, the present invention relates to a method, apparatus, and computer instructions for changing a pointer based on rate of movement of a pointing device.

### BACKGROUND OF THE INVENTION

A Graphical User Interface (GUI) is a graphics-based user interface that includes icons, pull-down menus and a pointing device. A pointing device is an input device used to move the pointer on screen. The pointer may also be referred to as the cursor. The major pointing devices are the mouse, trackball, pointing stick, joystick, electronic pen, and touch pad. The GUI has become the standard method for interacting with a computer. The three major GUIs are Windows, Macintosh, and Motif. The desktop manager and the window manager make up the GUI. The desktop manager is the part of a GUI that allows icons and files to be visually dragged and dropped, Drag and drop is a GUI capability that lets you perform operations by moving the icon of an object with a pointing device into another window or onto another icon. For example, files can be moved or copied by dragging them from one folder to another folder. Drag and drop is used for graphics applications where the pointer needs to be positioned on text or images.

Users of today's common GUIs are accustomed to working with pointing devices, such as a mouse. Typically a movement of the pointing device by the user's hand causes a proportionate movement of the pointer on the screen. Sometimes it can be a visual strain to find the pointer on the screen. Users often resort to rapid movements of the pointing device and try to then find the pointer by observing it quickly moving against a static background gradient. Even still, it can be arduous to find the pointer while it is moving.

Therefore, it would be advantageous to have an improved method, apparatus, and computer instructions for changing a pointer based on rate of movement of a pointing device so that the pointer is easier to view.

### SUMMARY OF THE INVENTION

The present invention provides a method, apparatus, and computer instructions for changing a pointer based on rate of movement of a pointing device. The present invention automatically changes a pointer based on user defined thresholds and the rate of movement of the pointing device. The user defines the changes for the pointer with respect to given thresholds.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein.:

FIG. 1 depicts a pictorial representation of a data processing system in which the present invention may be implemented;

FIG. 2 is a block diagram of a data processing system that may be implemented in accordance with a preferred embodiment of the present invention;

FIG. 3 is a block diagram of a pointing device that may be implemented in accordance with a preferred embodiment of the present invention;

FIG. 4 is a graph depicting change in distance and change in time to show when a threshold is met in accordance with a preferred embodiment of the present invention;

FIG. 5 is a block diagram of a pointer displayed in a graphical user interface in accordance with a preferred embodiment of the present invention;

FIG. 6 is a block diagram of an updated pointer displayed in a graphical user interface in accordance with a preferred embodiment of the present invention; and

FIG. 7 is a flowchart of the process to determine the attribute variance of a pointing device based on a threshold in accordance with a preferred embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes system unit. 102, video display terminal 104, keyboard 106, storage devices 108, which may include floppy drives and other types of permanent and removable storage media, and mouse 110. Additional input devices may be included with personal computer 100, such as, for example, a joystick, touch pad, touch screen, trackball, pointing stick, electronic pen, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

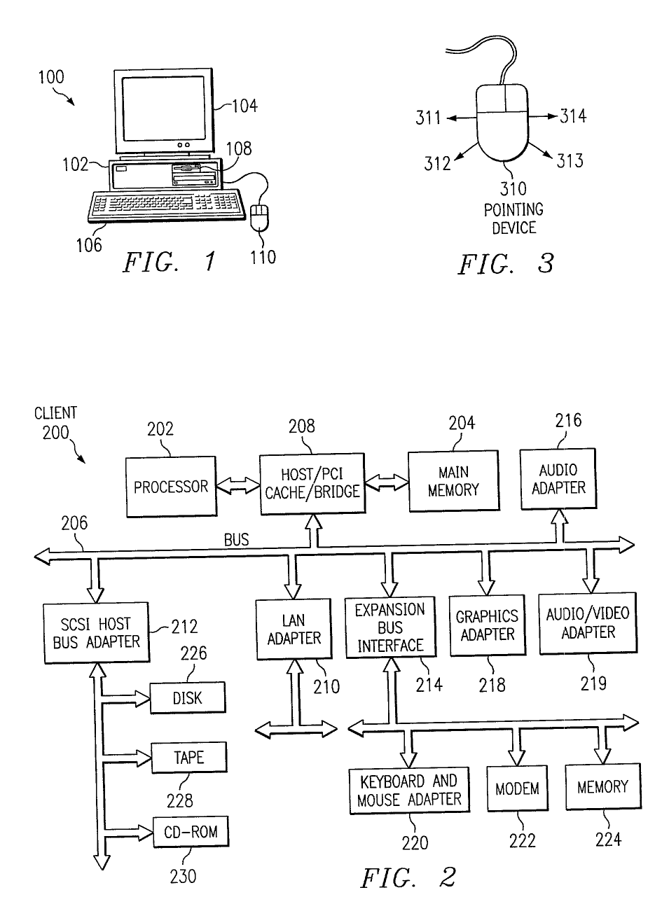

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object-oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or handheld computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

FIG. 3 is a block diagram of a pointing device, such as mouse 110 in FIG. 1, that may be implemented in accordance with a preferred embodiment of the present invention. Pointing device 310 may be connected to mouse adapter 220 in FIG. 2. The present invention enhances a pointing device driver by allowing the user to define multiple changes to the pointer when the pointing device, such as pointing device 310, is moved at some predetermined speed or acceleration. The pointing device driver software program detects if the pointing device is moved rapidly enough to cross a threshold of speed.

If the movement, represented by arrows 311, 312, 313, and 314, is greater than a threshold set by the user, the appearance of the pointer will be changed as defined by the user.

The depiction of pointing device 310 as a mouse is presented for purposes of illustration and is not meant as an architectural limitation to the type of pointing device that may be used with the mechanism of the present invention. The mechanism of the present invention may be implemented using a variety of pointing devices, such as for example, a trackball, a light pen, a touch pad, a keyboard, or a joystick.

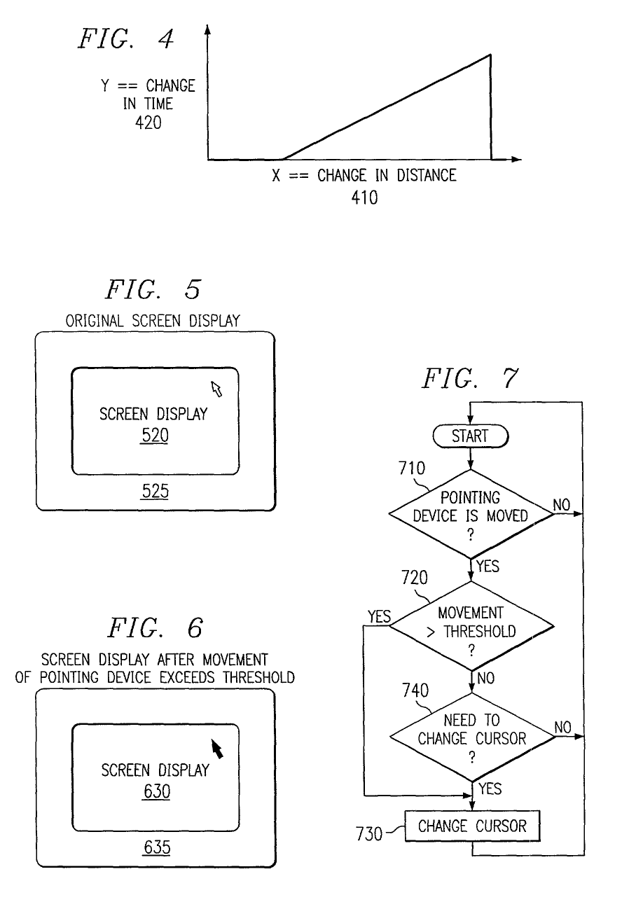

FIG. 4 is a graph depicting change in distance and change in time to show when a threshold is met in accordance with a preferred embodiment of the present invention. The measurement of movement for the pointing device is represented as dX/dY (acceleration, or slope), where X-axis 410 is distance and Y-axis 420 is the time interval during which the distance was traversed by the pointer. If the measurement of movement falls in the shaded area on the graph, the threshold has been surpassed.

Turning now to FIG. 5, a block diagram of a pointer displayed in a graphical user interface is shown in accordance with a preferred embodiment of the present invention. The present invention allows a user to define multiple changes to a pointer displayed in a graphical user interface, such as pointer 520 and graphical interface 525, based on a threshold. The appearance of pointer 520 may be changed when the rate of movement of the pointing device exceeds a given threshold so that pointer 520 is easier to view.

FIG. 6 is a block diagram of an updated pointer displayed in a graphical user interface in accordance with a preferred embodiment of the present invention. For example, the appearance of pointer 520 in FIG. 5 could be changed to pointer 630 as shown in graphical interface 635 when the movement is greater than a given threshold. The changes to the appearance of pointer 520 in FIG. 5 may include attributes such as size and color as display by pointer 630.

According to the present invention, pointer changes evoked could be any one or combination of many possibilities. One possibility could be to change the color and line thickness of the pointer to stand out more. For instance, a pointer with a thin black line could be changed to a thick red line. Other possible visual changes to the pointer include, for example, blinking, increased brightness, and various other options. Multiple thresholds may be set to invoke multiple changes to a pointer. A series of changes may occur based on the magnitude of the rate of change in movement. For example, a fast movement of the pointer could change the pointer to a red arrow with brightness and line thickness aspects of ‘5’. A faster movement could accentuate the change to a red arrow with brightness and line thickness aspects of ‘9’.

Another function of the present invention is to change 20 back to a previous presentation of the pointer if and when dX/dY decreases below a threshold set to invoke a change to the pointer. Thresholds may be reached by increasing or decreasing the motion of the pointing device, therefore, affecting the appearance of the pointer based on thresholds and associated pointer changes set by the user.

FIG. 7 is a flowchart of the process to determine the attribute variance of a pointing device based on a threshold in accordance with a preferred embodiment of the present invention. The process illustrated in FIG. 7 may be implemented in a pointing device driver in a data processing system, such as data processing system 200 in FIG. 2.

The process begins with a determination being made as to whether a pointing device has been moved (step 710). If the pointing device has been moved, a determination as to whether the measurement of movement of the pointer is greater than a given threshold is made (step 720). If the movement is greater than the threshold, the pointer is changed as specified (step 730) with the process returning to beginning at step 710.

If the movement of the pointer is not greater than the threshold, determine if the pointer needs to be changed (step 740) with the process returning to beginning. A pointer may need to be changed if the rate of change of motion decreased below the given threshold and the pointer is defined to return to a previous presentation.

Thus, the present invention provides an improved method, apparatus, and computer instructions for viewing a pointer. Users currently often resort to rapid movements of the pointing device to locate the pointer in a GUI environment. This habit or conditioned manipulation of the pointer through the pointing device lends itself to the mechanism of the present invention, which alters or changes a presentation of the pointer to make the pointer more apparent to the user. The present invention makes it easier to view and locate the pointer by changing a presentation or display of a pointer based on the rate of movement of a pointing device used to manipulate the pointer.

It is important to note that while the present. invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal-bearing media actually used to carry out the distribution. Examples of computer-readable media include recordable-type media such a floppy disc, a hard disk drive, a RAM, CD-ROMs, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. For example, in the depicted examples, the rate of movement of the pointer compared to a threshold is in a form of speed or velocity. Acceleration or the rate of change in speed or velocity of the pointer may also be a measurement used to change the attribute or presentation of the pointer in the present invention. Another method for the present invention is the measurement of the tactile force applied to the pointing device since some pointing devices can provide tactile feedback to the user. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for changing a pointer, the method comprising:
receiving a user input indicating that a pointing device was moved;
calculating a rate of movement for the pointing device;
comparing the rate of movement with a given threshold of speed; and
automatically updating a presentation of the pointer based on the given threshold of speed in response to receiving the user input, wherein a presentation of the pointer is altered if the rate of movement exceeds the given threshold of speed.

2. The method of claim 1, wherein the change for the pointer is associated with the given threshold of speed.

3. The method of claim 1, wherein other thresholds are present in addition to the given threshold of speed and wherein the pointer is changed each time one of the other thresholds is exceeded.

4. The method of claim 1, wherein the presentation of the pointer is a series of different changes in presentation based on the rate of movement for the pointing device.

5. The method of claim 1, wherein the pointer returns to its previous appearance when the rate of movement for the pointing device decreases below the given threshold of speed.

6. The method of claim 1, wherein the threshold is a measurement of a distance traveled with respect to a time interval for the distance traveled.

7. The method of claim 1, wherein the pointing device is one of a mouse, a pointing stick, a touch pad, a joystick, a key on a keyboard, an electronic pen, or a trackball.

8. The method of claim 1, wherein the updating step includes:
changing the color of the pointer.

9. The method of claim 1, wherein the updating step includes:
changing the shape of the pointer.

10. The method of claim 1, wherein the updating step includes:
changing the size of the pointer.

11. A method in a data processing system for changing a pointer, the method comprising:
receiving a user input specifying a threshold;
defining a change for the pointer; and
associating a threshold of speed with the change for the pointer.

12. The method of claim 11, wherein multiple thresholds are defined for changing the pointer.

13. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a user input indicating that a pointing device was moved; calculate a rate of movement for the pointing device; compare the rate of movement with a given threshold of speed; and automatically update a presentation of the pointer based on the given threshold of speed in response to receiving the user input, wherein a presentation of the pointer is altered if the rate of movement exceeds the given threshold of speed.

14. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a user input specifying a threshold; define a change for the pointer; and associate a threshold of speed with the change for the pointer.

15. A data processing system for changing a pointer, the data processing system comprising:
receiving means for receiving a user input indicating that a pointing device was moved;
calculating means for calculating a rate of movement for the pointing device;
comparing means for comparing the rate of movement with a given threshold of speed; and
updating means for automatically updating a presentation of the pointer based on the given threshold of speed in response to receiving the user input, wherein a presentation of the pointer is altered if the rate of movement exceeds the given threshold of speed.

16. A data processing system for changing a pointer, the data processing system comprising:
receiving means for receiving a user input specifying a threshold;
defining means for defining a change for the pointer; and
associating means for associating a threshold of speed with the change for the pointer.

17. A computer program product in a computer readable medium for changing a pointer, the computer program product comprising:
first instructions for receiving a user input indicating that a pointing device was moved;
second instructions for calculating a rate of movement for the pointing device;
third instructions for comparing the rate of movement with a given threshold of speed; and
fourth instructions for automatically updating a presentation of the pointer based on the given threshold of speed in response to receiving the user input, wherein a presentation of the pointer is altered if the rate of movement exceeds the given threshold of speed.

18. A computer program product in a computer readable medium for changing a pointer, the computer program product comprising:
first instructions for receiving a user input specifying a threshold;
second instructions for defining a change for the pointer; and
third instructions for associating a threshold of speed with the change for the pointer.
